(19) United States
(12) Patent Application Publication
(10) Pub. No.: US 2014/0267391 A1
(43) Pub. Date: Sep. 18, 2014

(54) IMAGERY-BASED CONTROL AND INDICATION OVERLAY FOR PHOTOVOLTAIC INSTALLATIONS

(71) Applicant: Maxout Renewables, Inc., Livermore, CA (US)

(72) Inventor: Eric B. Cummings, Livermore, CA (US)

(73) Assignee: Maxout Renewables, Inc., Livermore, CA (US)

(21) Appl. No.: 14/195,551

(22) Filed: Mar. 3, 2014

Related U.S. Application Data
(60) Provisional application No. 61/789,110, filed on Mar. 15, 2013.

(51) Int. Cl. G06T 11/60; G06T 11/20

(52) U.S. Cl. CPC G06T 11/60; G06T 11/206
USPC 345/629

(57) ABSTRACT

A control and monitoring system for solar panels includes visual overlays of information and control functions over a static image of the solar panels. Custom indicators and control mechanisms allow an operator to continuously monitor a plurality of solar panels and pin point with ease any individual solar panels that may be malfunctioning due to one or many reasons. In addition, the control system provides ability to remotely control certain operations of each individual solar panel.

### CROSS-REFERENCE TO RELATED APPLICATION

This is a non-provisional U.S. Provisional Application No. 61/789,110, filed Mar. 15, 2013, and is hereby incorporated by reference herein in its entirety for all purposes.

### BACKGROUND

Photovoltaic panels (or PV panels) are commonly used for harnessing solar energy and converting the solar energy into other forms of energy including electrical energy and thermal energy. PV panels are used in residential as well as commercial or large-scale power generation. However, the current methods for monitoring and controlling a PV installation have several issues.

Maintaining, troubleshooting, and optimizing the power output of a solar array or solar power plant can be complicated by an absence of convenient indicators or controls. While computer controls and monitors may exist, it may be difficult, error-prone, or time consuming to ascertain the link between these indications and controls and physical power generators, such as photovoltaic (PV) modules, concentrated photovoltaic (CPV) modules and the like. Similar problems exist with the ability to troubleshoot banks of batteries and with many other cost-sensitive systems. Solar power plant maintenance is further complicated by the physical expanse and quantity of modules.

There is a need for low-cost systems that provide indicators of performance, faults, etc. and, in some cases, provide controls that are intuitively and obviously linked to the device or system that they are indicating or controlling. Many sources of underperformance of a PV module or CPV module may be evident on visual inspection, e.g., shading, surface fouling, breakage, water ingress, etc. There is therefore an advantage to providing a visual indication of performance of the PV or CPV modules for diagnostic purposes.

### SUMMARY

Embodiment of the present invention generally relate to solar power modules. Some embodiments of the present invention are directed to display of performance and other parameters and provide control functions for solar power modules in a PV or CPV installations.

Developments of smart phones, tablets, laptops, wearable imagers and screens in goggle form, as well as faster and lower cost processors fuses brings together the elements that may facilitate a novel technique of indicating and controlling solar installations via virtual indicators and controls overlaid visually on saved or real-time imagery of an installation. In some embodiments, this can be achieved in concert with acoustic signals and vocalizations that produce a further indication of the location of a monitored or controlled object.

Embodiments of the present invention provide an image overlay and may be applied in small-scale installations, e.g., household or commercial installations and large-scale installations. Different data may be conveyed at different resolution and granularity.

Some embodiments of the present invention establish an intuitive link or an illusion of an intuitive control or indication present at an image. Visual enhancements such as ‘auras,’ highlights, colors, drop shadows, contrast enhancements and reductions, animations, gradients, bitmaps, blurs, sharpings, added noise, transparencies, layering, masking, etc. may be employed to compose a human interface that is easily understood, is stress or uncertainty reducing, and reduces or eliminates errors. Because the controls and indicators are not limited to traditional physical indicators and controls, the overlays may provide a substantially enhanced and safer experience than conventional controls.

### BRIEF DESCRIPTION OF THE DRAWINGS

FIG. 1A shows an image of a sample PV installation with samples of overlaid indicators according to an embodiment of the present invention.

FIG. 1B shows an image of the PV installation in FIG. 1A at a different vantage point showing how overlays may change with viewing position according to an embodiment of the present invention.

FIG. 2 shows an indicator and control-overlaid image of a PV plant from a maintenance worker's vantage point according to an embodiment of the present invention.

FIG. 3 shows an indicator-overlaid image of a PV plant from a plat operator's or maintenance dispatcher's display according to an embodiment of the present invention.

FIG. 4 shows techniques of mapping positions of devices within an image to a physical position and mapping devices by their functional ordering according to an embodiment of the present invention.

FIG. 5 is a block diagram of a computer system that may be used to implement the various embodiments of the present invention.

### DETAILED DESCRIPTION

Embodiments of the present invention generally relate to solar panels. Specifically, some embodiments of the present invention provide techniques for monitoring individual solar panel in a solar panel installation by providing visual overlay image(s) over a static image of the solar panel installation. The overlaid image provided monitoring and control information for each individual solar panel in the solar panel installation.

The performance of many devices cannot be economically or practically indicated to or manually controlled by an “interested party,” herein defined as a consumer of information about device performance, such as an owner, user, maintainer, trouble-shooter, repairer, etc. In some cases, there is access that facilitates the use of a mobile indicator, such as a voltmeter, multimeter, oscilloscope, etc. However, in many cases there is no practical, economical, or safe access. In some cases performance data can be obtained via a digital link, possibly through one or more intermediate links, to the device or a device in communication with the device. For example, a string of solar panels on a rooftop of among many in a large field may be difficult to troubleshoot by making direct measurements, but may be connected to a device, such as a balancer, power optimizer, microinverter, inverter, monitor, etc. that can report a performance parameter to an interested party. As used herein “reports” means communicates directly, indirectly, via one or more analog or digital links, including acoustic, optical, RF, wireless, wired, connections in any parallel or digital arrangement.

It is well known in the art to display information in the various forms including hardware indicators such as LCD screens and LEDs, software-based indicators, e.g., text boxes, bar indicators, etc. Some such indications provide less information than may be desired by an interested party. For example, a display that reports the power production of an array of solar panels may not convey information about the placement of solar panels that would be useful in interpreting a result. For example, it may be difficult to pair a physical photovoltaic panel, battery, etc. in a string with a reported measurement, although such pairing may be of diagnostic utility.

As used herein, an “installation” comprises devices whose data is communicated in addition to contextual information about the relative position of devices.

Embodiments of the present invention include a visual overlay of at least one performance datum on a recognizable physical image of an installation. For example, some embodiments of the present invention overlay a text or graphical display of such data over a saved digital image of the physical objects, such as a picture, rendering, or drawing, of an actual installation. The data thus presented makes a pairing of data with the physical device intuitive.

Some embodiments of the present invention include a visual overlay of at least one performance datum on real-time images of an installation. Some embodiments of the present invention comprise a display on a device outfitted with an array imager and a display screen, such as a desktop, laptop, tablet, or wearable computer, smart phone, wearable display device, such as glasses or goggles, etc.

FIG. 1A shows an image 1000 of a sample installation that is overlaid with visual indicators of various arrangements and types. Rectangular elements 1002 may comprise PV panels, but could alternatively comprise CPV modules, individual solar cells, building-integrated solar, fuel cells, batteries, solar thermal collectors or receivers, etc. Element 1004 is a support structure associated with the installation and element 1006 is a sample “context” for the installation. In some embodiments, this may comprise a roof top, a house, ground, or other man-made or natural surrounding structure. In some embodiments, the image of this context provides meaningful visual cues that help to interpret an overlaid image. Visual elements 1008, 1010, and 1012 are respectively the top extent, bottom extent, and indicator edge of a bar-chart indicator that is overlaid on the image of the PV module it describes. In some embodiments, this bar chart may describe a performance parameter such as power output, relative or absolute efficiency, lost power, average power, rate of revenue generation, accumulated revenue, time since servicing, amount of fouling or shading, etc. Visual element 1014 can be overlaid text, e.g., the power produced by a panel compared to its power rating. A visual element 1016 may be employed to create an obvious link between a datum and its source, to highlight or draw attention to an object, etc. Element 1018 is a ‘drop shadow,’ of element 1016 whose alignment helps to create the illusion of a physical indicator, representative of the many such visual cues that may be adopted in implementations of the present invention to enhance intuition and the illusion of reality. The overlays 1020 may be augmented via animations, colors, intensity, border widths etc. to highlight or call attention to a device, for example to indicate a critically under-performing panel. Some overlays 1022 may be partly or wholly transparent so as not to obscure an image excessively. Visual element 1024 comprises a panel-aligned bar chart that is offset from the panel. In some embodiments, such charts are offset to provide an enhanced view of the device underneath. In some embodiments an offset produces a floating effect. In some embodiments, this floating effect is enhanced by adding perturbations to the position of the indicator that enhance an illusion. In some embodiments, distortions, such as ripples from rising thermals may be imposed on overlays, e.g., to convey or suggest temperature information. Visual element 1026 is an overlay of a bar chart showing two data, for example, a breakdown of the total power produced by a panel into a normal string power and a balancer-harvested power. Some overlays 1028 can be clipped or cropped by foreground objects. Some embodiments project overlays on a saved image of an installation. Some embodiments project overlays on an updated or real-time image of an installation from a fixed vantage point. An advantage of the use of a fixed vantage point is the dramatic simplification of establishing the position of devices within an image.

Some embodiments of the present invention are capable of finding or calculating the position of devices within an image having a variable vantage point and orientation. FIG. 1B shows an overlaid image 1100 of the installation in FIG. 1A from an alternate vantage point. The relative positions of indicators substantially retain their relationship to their respective models. In some embodiments, it may be prudent to maintain a more observer-normal relationship of text, e.g., 1102 and to provide a background for text to enhance its readability to avoid the difficulty in reading extremely skewed text, such as the power indication 1104.

FIG. 2 shows an overlaid 2000 image of a large solar installation from the vantage point of a maintenance worker or field-level camera according to according to an embodiment of the present invention. Elements 2002 are an array of PV strings. An objective of the present invention is to make the task of maintaining, diagnosing, and optimizing large arrays. In some embodiments, the overlay ‘clutter’ is curtailed so that only data for problematic panels is indicated. For example, a datum 2004 and/or a visual director 2006 is overlaid to help guide a maintenance worker efficiently to trouble. Some alternative visual directors may take the form of a descriptive bubble or tooltip 2008. Some directors may include animations that show an efficient path or point toward the destination. Visual elements 2010 may comprise a state indicator and a control. For example, performing a selection operation analogous but not limited to a mouse click or double-click, including a gesture, gaze, hover, touch, tap, double tap, drag, etc. on a touch-sensitive image at 2010 or using a cursor positioned at 2010 may toggle a panel from one state to another, e.g., actively bypassed to operating. Visual elements 2012 and 2014 may be respectively azimuth and elevation indicators and controls. Element 2016 may indicate the current position of the array azimuth. Element 2018 may indicate a motion of the azimuth and may alternatively or additionally comprise an animation and element 2020 may be a control that can be operated by sliding, dragging, arrow keys, and the like. Visual element 2022 comprises a highlight and ‘aura’ or shading around a panel, e.g., to indicate a problem and assist with visually inspecting the panel. In addition, an indicator or control 2024 associated with such a panel may change color, transparency, etc. and may slew away from the image of the panel so as not to interfere with a visual inspection via image 2000. Overlaid elements 2026 are semi-transparent indicators that may be displayed for nearby panels or strings that are otherwise addressed. Nearness may be measured by the intensity of a weak radiated field (optical, RF, acoustic, etc.) that is transmitted by apparatus associated with a string or with a camera or vice versa. In some embodiments, this field comprises a data channel, e.g., Bluetooth, IrDA, etc. Overlaid visual element 2030 is a sample embodiment of a virtual control according to the present invention, e.g., a boost or bypass power setting for a balancer. In some embodiments a text indicator or control 2032 may be displayed to provide more quantitative control and indication. Visual overlay element 2034 is a drop-shadow to assist with positively associating an indicator with a device. Visual overlay element 2036 is an embodiment of a highlight of a control, which may comprise an animation, e.g., changing color, waving, shimmering, changing transparency, rising heat distortions, etc. to convey intuitive information about the reason for highlighting, for aesthetics, etc.

FIG. 3 shows an overlaid image 3000 according of a solar field from a distant vantage point, e.g., an image from an aircraft, satellite, tower, etc. according to an embodiment of the present invention. In some embodiments this image may be a static image. In some embodiments, a camera may be able to zoom and rotate to provide alternate views. This kind of view may be useful for a plant operator or maintenance dispatcher. While image 3000 contains only indicators, it may further comprise controls. Moreover, selecting an object may cause a camera to zoom in on that object. It may initiate a change to an alternate overlaid image at higher resolution of a string or of a similar string or string model that may have provide additional indication and controls. An objective of this ‘over-view’ is to highlight problem spots. For example visual elements 3002 may direct an operator's focus to arrays and/or individual panels/modules that are indicating a fault, behaving abnormally, under-performing, etc. Elements 3004 may be displayed to provide additional data. In some embodiments, the power production of each module or string may be indicated by colorization. In such a scheme, visual elements 3006 may indicate significantly underperforming or bypassed panels.

As used herein, a “mapper” is defined as an object, including a person or electronic processor, that identifies a link between at least one digitized position and a device identifier. FIG. 4 shows an overlaid image 4000 of a string of solar modules 4002 undergoing a mapping procedure. In some embodiments, a mapping is created between the devices of an installation and an image or drawing of an installation via a manual technique, such as identifying or delineating a region of an image and a linking this with at least one datum herein called an “identifier” used to associate at least one datum with a device. An identifier may an electrical position of a device within string, device address, name, code, serial number, or other discriminator. In some embodiments this mapping procedure may be repeated. For example the mapper may define vertices that lie on the image of the corners of a panel 4002 to produce a simplified model of the panel outline 4004.

As used herein, “focus” means having the instantaneous attention, such as having a cursor atop, a touch atop, a gesture at, a gaze at, a pointer at, etc. As used herein, “hover” means to indicate attention to an object by shifting focus to that object in a non-casual manner so as to exclude incidental or transitional shifts in focus. As used herein, “select” means to convey a confirmation of focus, e.g., via a touch-screen or pad, mouse, cursor, joystick, trackball, pointer, button, eye gaze, gesture, vocalization, hover, or other user input operation known in the art or developed to perform such a conveyance. The method of selection may initiate different actions in the same manner that a mouse left click, left double-click, and right-click may produce different outcomes defined in software. These distinctions reflect programming choices that are well known in the art. The term “select” refers to all manners of confirmation, noting that different means of selection may be used to discriminate intent. In some embodiments, image processing is utilized to assist and accelerate a mapping procedure. For example, an image of a photovoltaic array may be processed to identify features of a panel, such as solar cells, frames, indicia, 1-d or 2-d barcodes, or other fiducial marks. A mapper may then select a point within a region identified via image processing. In some embodiments a mapper may select a point 4008 on a panel 4002 and image processing may be employed to identify the extents or outline 4010 of the selected device/panel automatically. In some embodiments, a mapper may select the outline of a device. In some embodiments, a mapper may “drag” an icon or other indicator atop a device, as the term “drag” is commonly used to mean an operation in which a virtual object is moved and manipulated. The extents of a physical device may be “dragged” into place. Some embodiments may comprise a sequence of image processing, selection, and dragging to define the extents of a physical device in an image.

In some embodiments, the order of selection may indicate an ordering 4012 of devices, e.g., incrementing device identifier, position in a string, address, etc. In some embodiments a mapper may reorder devices by editing a property or moving an icon, outline, selecting (e.g., clicking, touching, gazing, etc.) within a plurality of identified regions in an order, etc. In some embodiments, the order of selection and in some embodiments the outline of a selection may be determined via a procedure in which at least one device is perturbed and the effect of the perturbation observed. For example, a solar panel may be short circuited or open-circuited or otherwise operated away from a nominal operating point, thereby changing its temperature. This temperature change may be observed or imaged remotely providing the information needed for mapping without the need for manual selection. In some embodiments, this procedure may be repeated sequentially or otherwise deterministically at least one other device in a string.

In some embodiments, the mapping between device and position is based on a design, drawing, model, or other representative image rather than a picture of particular device. For example, a solar installation may comprise a large number of substantially identical strings. It may be convenient to perform a mapping operation and use this mapping for more than one string. In some such cases a string may by indexed by a second identifier. In some embodiments, this second identifier may be mapped to at least one coordinate. In some embodiments, information about the relative position of substantially identical strings is also mapped, e.g., by selection of a point on a string in an image showing a plurality of such strings. For example an image, sequence of images, or video from an aerial camera, satellite, tower, etc. In some embodiments mapping of multiple strings may be derived from a model, design, equation, or drawing. As used herein, the term “overlay” refers to a combination, within a displayed image, of background image information and additional information via a mathematical operation, e.g., multiplication, addition, subtraction, and, or, xor-ing, color modification, alpha-blending, over-writing, etc. as known in the art. In some embodiments, a plurality of data may be overlaid. In some embodiments the present invention may comprise a ‘heads up display’, wherein only overlays are displayed. In some such embodiments, overlays are composited with an image of the actual scene by superposition on the viewer's retina.

In some embodiments, performance data may be visually encoded as text, a ‘bar chart,’ ‘pie chart,’ ‘gauge image,’ line, shape, etc. In some embodiments, performance data may be visually encoded as an image region containing an overlaid color map, look-up table, gray-scale. In some embodiments an overlay may comprise visual information that is not related to performance, e.g., electrical schematic information, an identifier, etc. In some embodiments, visual objects may be overlaid for aesthetic purposes, to enhance readability, or to effect a visual representation of a software control, such as a ‘handle,’ ‘button,’ ‘link,’ etc. In some embodiments an animation may be used to indicate a status, error condition, or the like. In some embodiments an overlaid object may be mapped according to the image of a device within the displayed image. For example, an overlaid object may be warped, skewed, foreshortened etc. in a manner similar to that of the device in an image, for example, to provide an indicator that visually lies upon, above, or at an orientation and offset relative to a device. In some embodiments, virtual, overlaid indicators and controls may be displayed or rendered consistent with the appearance of analogous actual indicators and controls. In some embodiments, some overlaid objects are displayed as two-dimensional projections of three-dimensional objects. In some embodiments, stereo vision may be employed to render three-dimensional objects or convey the three-dimensional relationship between objects, e.g., near vs. far. In some embodiments, overlaid data may be a color that indicates a performance parameter. In some embodiments, visual cues, such as rendered effects, drop shadows, shading, shine, glare, fog, transparency effects may be used to enhance the aesthetics, readability, realism, representation, intuition, etc. of an overlay. In some embodiments, overlays are rendered such that nearer overlays are visually in the foreground of further overlays, e.g., an overlay may partly obscure, defocus, darken, lighten, recolor, etc. the image of an overlay that is behind the overlay.

In some embodiments, a performance parameter is conveyed via animation of an overlay, e.g., rate of rotation, rate of sweep, periodic pulsations of color, hue, intensity, transparency, etc. In some embodiments an animation may be used to indicate a status, error condition, or the like. In some embodiments, an overlay may comprise a recognizable icon, e.g., an ISO warning, danger, or message symbol to indicate a particular risk such as the presence of high voltage or other information. Some embodiments may comprise other intuitive icons, e.g., a ‘lightning bolt’, an exclamation mark, fire, thermometer, pressure gauge, etc. Some embodiments may comprise animated icons or icons whose orientation and position are animated, e.g., oscillated in position, rotated about an axis, etc. In some embodiments, icons may be simulated views of three-dimensional objects. In some embodiments, icons may function similar to their role in computer interfaces. In some embodiments, selecting an icon may pull up an overlaid window containing related information. For example, selecting a fault icon may pull up an overlay comprising detailed text description of a fault, a check list for repairing the fault, a ‘wizard’ for assisting with trouble-shooting the fault, a web-page, a virtual control and indicator panel, a video, a text, audio, or video ‘chat’ interface, etc. In some embodiments selecting an overlay may pull up a user's manual, warranty information, a vendor's website, etc. In some embodiments, selecting an overlay or object in an image may result in choosing that object for further scrutiny. As used herein an “interface to an object” is a unidirectional or bidirectional data link relevant to that object. An interface may link to control or measurement apparatus associated with an object. An interface may link to information about an object. An interface may link to information stored locally, remotely, on web pages, etc. In some embodiments, selecting an object in an image may open an interface to an object. In some embodiments, hovering or passing focus over an imaged object may produce a highlight comprising a visual cue, audible cue, or tactile cue, e.g. an impulse from a vibrator motor to indicate that an interface to an object is available. In some embodiments the highlight may indicate the nature of the interface available, e.g., control, indication, information, etc.

In some embodiments, a plurality of objects may be overlaid. In some embodiments, overlays may convey different information, may have different spatial mapping relative to a devices. For example, a device may have an overlaid bar chart whose corners are related to those of the device image such that the bar chart lies upon or near an image of the device, text may appear at a different orientation and offset, e.g., vertically oriented and offset, but rotated to align with an edge or rotated normal to the image. In some embodiments, the data overlaid on an image may be different at different image resolution. At low resolution, e.g., when an image of an individual device spans a relatively small number of pixels (e.g., between 1 and 100), data about a plurality of devices may be displayed rather than individual device data. Some embodiments may present an image of performance as an image in which each pixel is related to the weighted combination of a performance parameter of devices whose positions the pixel spans. For example such an overlay may comprise an image of the power production density or maintenance priority of all or part of a field of solar panel strings, etc.

In some embodiments, overlays may be selected to trigger a software event, for example, to trigger a message like a traditional ‘button click’ or ‘double-click.’ In some embodiments, an overlay may change visual appearance when a pointer, cursor, gesture, touch, gaze, and the like lies near the overlay to provide visual feedback. In some embodiments an overlay may change visual appearance when ‘clicked upon,’ ‘touched,’ ‘gestured to,’ ‘gazed at’ ‘hovered over’ or another like event commonly used in the art to perform a selection, e.g., trigger a conventional button click or double click message. In some embodiments an overlay may change appearance while the software is processing a message or a device is executing a particular operating mode or routine. In some embodiments, an overlay may change its appearance when the software is finished processing a message or a device changes mode or completes executing a routine. In some embodiments the location and orientation of an imager is entered manually, obtained through satellite imagery, established via satellites, e.g., GPS satellites, established via data from cellular phone transceivers, established via an acoustic, optical, or RF signal transmitted or received by a device co-located with or having an otherwise determined position relative to a string, etc. In some embodiments the location and orientation of an imager may be obtained via visual information within an image, e.g., fiducial marks, one and two dimensional bar codes, geographic features, buildings, and other visual elements. In some embodiments a position or orientation is established using an image correlation. Some embodiments refine a position or orientation estimation by repeating a correlation or identification of visual elements taken from a plurality of images obtained at multiple positions or orientations. Some embodiments estimate the orientation of an image using a reading of magnetic north, e.g., via a compass, compass image, electronic compass, etc. Some embodiments estimate the position or orientation of an image from visual elements, including stored visual elements and those fetched from a remote data base, e.g., Google Earth, etc. In some embodiments, the position and orientation estimation employs a gyroscope including a MEMs gyroscope, an accelerometer, including a MEMs accelerometer, a vertical reference, e.g., a sensor of the angle of the gravitational force. Some embodiments employ a plurality of linear inertia sensors, a plurality of angular inertia sensors, or a combination of such sensors in position estimation.

Some embodiments of the present invention identify an installation or string within an installation by use of an estimate of the imager position and orientation. In some embodiments, the position and orientation of a device in an image is calculated relative to the imager position and orientation. In some embodiments the absolute coordinates of features of a device, e.g., corners are saved in a retrievable format locally or remotely. As used herein, “retrievable format” means one that is able to be fetched and used by a processing device, e.g., from EEPROM, EPROM, RAM, thumbdrive, data card, disk, database, network, or remote database, remote disk, remote computer, remote network, remote device etc., via a communications link, e.g., wired, fiber, wireless, cellular, 3G, 4G, cable, DSL, WiFi, Zigbee, Bluetooth, etc. In some embodiments, relative coordinates are saved. In some embodiments an absolute coordinate is saved from which absolute positions may be inferred from saved relative positions. In some embodiments, inaccuracies in relative or absolute position are corrected via an image processing procedure, e.g., by correlation, feature detection, comparison with a saved image, video, etc.

In some embodiments, a comparatively time-consuming position and orientation estimation procedure may be employed to obtain a coarse estimate of the position of a device within an image. In some embodiments, estimates are refined via image processing. In some embodiments, the position estimates are update in real-time or periodically using an efficient motion-estimation routine. In some embodiments data from linear and angular accelerometers may be used to facilitate real-time position and orientation change estimation. In some embodiments, overlays are displayed in an image, sequence or images, or video relative to the locations of devices in real time. An objective of the present invention is to produce an illusion of an indicator paired with a physical device in an installation. The ability to track position and orientation of devices and project overlays coordinated with these positions in real-time imagery may help to enhance this illusion. In some embodiments, foreground objects within an image may partially or totally obscure, blur, or modify overlays to advance the fidelity of this illusion.

In some embodiments it is desirable to be able to display an un-obscured, highlighted, or enhanced image of a device within a larger image. Such visual information may be helpful in diagnosing a performance deficit, e.g., from surface fouling, water ingress, etc. In some embodiments, measurements or indicators may be overlaid so as not to obscure visual information of diagnostic interest. In some embodiments, overlays of objects such as arrows, pointers, animated arrows, ‘bubbles,’ ‘tooltips,’ ‘halos,’ ‘auras’ and the like may assist with quickly finding an underperforming device. In some embodiments, an interested party may be directed to a device that is outside of the visual range of an image by an overlaid arrow, text, distance indication, orientation indication, etc. In some embodiments, indications may be audible, such as directions, e.g., “proceed 25 meters to your left, then turn north,” or “highlighted panel is under-producing by 11%.” In some embodiments, a stereo or other multi-channel audible indication is controlled, via amplitude, frequency envelope, and phase to produce the illusion of the source originating from a device or installation, especially a device or installation that is referenced by the audible message. In some embodiments, voice recognition may be used to control, or manipulate the software generating the overlaid images or the devices or installations.

In some embodiments, simulated controls are projected as overlays and manipulated using touch, click, gesture, gaze, vocalization, motion, etc. For example, the bypass current in a balancer device connected to a panel may be adjusted by virtually sliding a virtual linear slide control. A recalibration may be forced by virtually actuating a virtual button. A parameter may be set by indicating a value, e.g., vocally, by actual or virtual typing, by adjusting a virtual knob or slider, by adjusting an actual knob or slider that is virtually linked to a device or installation, etc. In some embodiments, solar-tracking hardware may be similarly controlled, e.g., via sliding a touch across a projected arced arrow oriented in the corresponding plane of actuation. In some embodiments, the extents of projected arcs correspond to motion limits. In some embodiments the current and target set points are highlighted or otherwise indicated. Some embodiments may be visually designed such that the position of a feature of the image of an array, e.g., a support bar, cable, truss, tube, fiducial, etc. indicates the current position. Intuitively ‘dragging’ or sliding such a featured object may be used to control a tracker. In some embodiments, controls appear in the context of an imaged feature that is given focus, e.g., by a gesture, touch, mouse or trackball ‘hover’, etc.

In some embodiments, a measurement of an ambient condition, such as insolation, direct-normal insolation, temperature, etc., is available in a retrievable format, e.g., via a local sensor, networked sensor, or weather data source. In some embodiments, this data and possibly other information, such as the azimuth and elevation of the sun, atmospheric model, aerosol measurement, orientation of photovoltaic panels, etc., is used in connection with a model to produce an estimate of lost productivity of a device. For example, a measured device power may be compared with model of the performance of a device to calculate an efficiency or fraction of lost production. In some embodiments data is overlaid on a panel as a shape wherein the projected area of the shape onto the device image conveys a datum. For example, a bar-chart may be projected onto the image of a rectangular photovoltaic panel such that the chart corners overlie or are offset from the corners of the panel. A bar in the chart may then overlie an area that has intuitive graphical significance. In some embodiments a power efficiency is charted in which the full bar scale is a maximal output, e.g., a panel rating or a calculated nominal module output, etc. The height or area of a bar relative to the full bar may be the real-time, averaged, or logged value of actual production, a deficit in production, a relative difference in production, etc. Such a display may have intuitive significance because it may indicate the relative effective area of a panel that is lost to inefficiency, cloud cover, etc. In some embodiments a bar may display the relative amount of power gained by the use of a balancer, power optimizer, or microinverter. In some embodiments a plurality of bars or areas may be projected in the same chart to depict a dissection of effects, for example, the base power produced by a panel in one bar and the power boost from a balancer in another bar. In some embodiments a plurality of bars may illustrate the relative values of mechanisms that reduce panel output, such as loss from non-ideal panel orientation, loss from higher-than-nominal temperature, loss from fouling, loss from aging, etc. Some embodiments may utilize projections of a pie chart or other relative-area-based indicator, particularly if the device has a circular shape.

In some embodiments, images may be obtained from one or more fixed-position devices, e.g., a camera mounted on a pole, tower, fence post, structure, building, array, etc. In some embodiments the orientation of a camera may be controlled remotely via software. In some embodiments the magnification or zoom state of a camera may be controlled remotely via software. In some embodiments, the position of a camera may be moved, e.g., by mounting it on an actuated rail or traverse, by mounting it on an actuated cable run, by mounting it on a free-standing remotely controlled platform, by mounting it on a robot, etc. Some such embodiments may endeavor to allow a central controller to perform triage or diagnostic tests without dispatching maintenance workers to the field. In some embodiments, the control of such cameras and camera platforms may be performed in part by an interested party. In some embodiments, control software may automatically arrange one or more cameras. For example, on detecting a fault, the control software may turn the focus of a camera to the faulted device or string and alert an operator of the problem.

Some embodiments of the present invention comprise a step performed during or following installation of an array in which an authorized or qualified person may create an image of an installation, locate positions of photovoltaic panels within an image, assign a device ordering, and save this configuration information. In some embodiments some or all of this information may be saved to memory that is internal to an array. In some embodiments some of all of this information may be saved to a remote database. In some embodiments, some of all of this information may be provided to an end user via one or more datafiles. Some embodiments of the present invention comprise software that communicates with a device capable of providing performance data regarding an installation. Some embodiments may project overlays on a saved static image of an array, e.g., an image loaded from a disk, remote server, or a device, such as a suitably equipped balancer, power optimizer, or inverter in an installation using saved position information. In some embodiments, software contains a ‘contractor mode’ in which these images and position settings can be entered or modified.

An objective of the present invention is to provide a high-quality control and indicator panel that is virtually tied to the function of a device, but that does not substantially increase cost or hardware requirements or require physical access to a device. A further objective is to provide greater utility, ease of use, and upgradability than is practical or possible with physical control and indicator hardware. Finally, an objective is to make dispatching, directing, and performing maintenance of a solar array or power plant as efficient, cost effective, safe, and enjoyable as practical. Together, these objectives provide for a dramatic increase in maintainability over prior-art solutions without substantial additional cost, enhanced production via timely detection and repair of faults, the ability to upgrade and take advantages of new imaging and microprocessor-input technologies as they become available.

FIG. 5 is a simplified block diagram of a computer system 500 that may be used to practice various embodiments of the present invention. In various embodiments, computer system 500 may be used to implement any of the systems illustrated in FIGS. 1-4 and described above. For example, computer system 500 may be used to implement the visual monitoring and control system for solar panels/devices described above. As shown in FIG. 5, computer system 500 includes a processor 502 that communicates with a number of peripheral subsystems via a bus subsystem 504. These peripheral subsystems may include a storage subsystem 506, comprising a memory subsystem 508 and a file storage subsystem 510, user interface input devices 512, user interface output devices 514, and a network interface subsystem 516.

Bus subsystem 504 provides a mechanism for enabling the various components and subsystems of computer system 500 to communicate with each other as intended. Although bus subsystem 504 is shown schematically as a single bus, alternative embodiments of the bus subsystem may utilize multiple busses.

Network interface subsystem 516 provides an interface to other computer systems and networks. Network interface subsystem 516 serves as an interface for receiving data from and transmitting data to other systems from computer system 500. For example, network interface subsystem 516 may enable a user computer to connect to the Internet and facilitate communications using the Internet. In other embodiments, network interface subsystem 516 may receive data from individual solar panels via a wired or wireless connection.

User interface input devices 512 may include a keyboard, pointing devices such as a mouse, trackball, touchpad, or a graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to computer system 500.

User interface output devices 514 may include a display subsystem, a printer, a fax machine, or non-visual displays such as audio output devices, etc. The display subsystem may be a cathode ray tube (CRT), a flat-panel device such as a liquid crystal-based display (LCD), or a projection device. In general, use of the term “output device” is intended to include all possible types of devices and mechanisms for outputting information from computer system 500.

Storage subsystem 506 provides a computer-readable storage medium for storing the basic programming and data constructs that provide the functionality of the present invention. Software (programs, code modules, instructions) that when executed by a processor provide the functionality of the present invention may be stored in storage subsystem 506. These software modules or instructions may be executed by processor(s) 502. Storage subsystem 506 may also provide a repository for storing data used in accordance with the present invention. Storage subsystem 506 may comprise memory subsystem 508 and file/disk storage subsystem 510.

Memory subsystem 508 may include a number of memories including a main random access memory (RAM) 518 for storage of instructions and data during program execution and a read only memory (ROM) 520 in which fixed instructions are stored. File storage subsystem 510 provides a non-transitory persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Computer system 500 can be of various types including a personal computer, a portable computer, a workstation, a tablet computer, a mobile communication device, a network computer, a mainframe, a kiosk, a server or any other data processing system. Due to the ever-changing nature of computers and networks, the description of computer system 500 depicted in FIG. 5 is intended only as a specific example for purposes of illustrating the preferred embodiment of the computer system. Many other configurations having more or fewer components than the system depicted in FIG. 5 are possible.

Also, while a number of specific embodiments were disclosed with specific features, a person of skill in the art will recognize instances where the features of one embodiment can be combined with the features of another embodiment. Also, those skilled in the art will recognize, or be able to ascertain using no more than routine experimentation, many equivalents to the specific embodiments of the inventions described herein. Such equivalents are intended to be encompassed by the following claims.

What is claimed is:

1. A device for displaying a graphical user interface comprising:
a processor;
a display coupled to the processor; and
a memory coupled to the processor,
wherein the processor is configured to display a graphical user interface, the graphical user interface comprising:
a first image of a plurality of solar panels, wherein each solar panel in the plurality of solar panels is individually identifiable;
a second image overlaid over the first image, the second image comprising at least one portion overlying a first solar panel from the plurality of solar panels, the at least one portion including:
a first visual indicator indicating power produced by the first solar panel; and
an second visual indicator indicating efficiency of the first solar panel.

2. The device of claim 1 wherein the first visual indicator comprises text.

3. The device of claim 1 wherein the first visual indicator comprises a bar graph.
